(19) United States
(12) Patent Application Publication
(10) Pub. No.: US 2021/0012740 A1
(43) Pub. Date: Jan. 14, 2021

(54) DRIVING METHOD AND DRIVING DEVICE OF DISPLAY PANEL, AND DISPLAY APPARATUS

(71) Applicant: HKC CORPORATION LIMITED, Shenzhen (CN)

(72) Inventor: Jianfeng SHAN, Shenzhen (CN)

(21) Appl. No.: 17/037,765

(22) Filed: Sep. 30, 2020

Related U.S. Application Data
(63) Continuation of application No. PCT/CN2019/076175, filed on Feb. 26, 2019.

(30) Foreign Application Priority Data
Jan. 30, 2019 (CN) 201910094529.7

(51) Int. Cl. G09G 3/36

(52) U.S. Cl. CPC G09G 3/3677; G09G 2310/08; G09G 3/3696; G09G 3/3688

(57) ABSTRACT

Disclosed are a driving method and a driving device of display panel, and a display apparatus. The method includes the following steps: a conduction time of a acquired first preset scanning driving signal is smaller than a conduction time of a second preset scanning driving signal; and pixel units of two adjacent rows in a driving period are alternately arranged and driven by different scanning driving signals.

### CROSS-REFERENCE OF RELATED APPLICATIONS

The present application is a continuation application of International Patent Application No. PCT/CN2019/076175, filed on Feb. 26, 2019, which claims the benefit of Chinese Patent Application No. 201910094529.7, titled “DRIVING METHOD AND DRIVING DEVICE OF DISPLAY PANEL, DRIVING APPARATUS, AND STORAGE MEDIUM”, filed in the National Intellectual Property Administration, PRC on Jan. 30, 2019, the entirety of which is hereby incorporated by reference.

### TECHNICAL FIELD

The present disclosure relates to the field of liquid display technology, and more particularly relates to a driving method of display panel, a driving device of display panel, and a display apparatus.

### BACKGROUND

Large size liquid crystal display panels are mostly configured in vertical alignment (VA) type or in coplanar switching (IPS) type.

Comparing VA liquid crystal technology with IPS liquid crystal technology, it can be found that VA liquid crystal technology has higher production efficiency and lower manufacturing cost, but it is inferior to IPS liquid crystal technology in optical properties and has obvious defects in optical properties.

Especially when it is suitable for large-sized display panels, see FIG. 1a. If the VA liquid crystal is viewed from a smaller angle during driving, for example, in front view, the brightness of pixels will change linearly with voltage, see the ideal curve in FIG. 1. If the display panel is viewed from a larger viewing angle, the brightness of the pixels will quickly saturate with voltage, causing serious deterioration of viewing angle quality, as shown in the actual curve in FIG. 1. Obviously, there is a big difference between the ideal curve and the actual curve, which makes the gray scale that should have appeared under a larger viewing angle change seriously due to deterioration, which also leads to color shift.

In order to improve the color shift problem of va liquid crystal, the general solution is to further divide the subpixels into main pixels and subpixels. See FIG. 1b, a curve representing the main pixel and a curve representing the subpixel b will be formed. Since the main pixel and subpixel will be displayed together, the actual curve in FIG. 1b will be obtained. Obviously, the actual curve in FIG. 1b is closer to the ideal curve than the actual curve in FIG. 1a. Therefore, if the display panel is viewed from a larger viewing angle after dividing the main pixel and the subpixel, the trend of the brightness of the pixel will be close to the trend of the voltage when viewing the display panel from a smaller viewing angle.

However, this way of dividing the main pixel from the subpixel will solve the color shift problem by giving different driving voltages to the primary and secondary pixels in space, which will result in the need to redesign the metal wiring or thin film transistor (TFT) elements to drive the subpixel when designing the pixel, which will result in the sacrifice of the transparent opening area and further affect the panel transmittance.

Therefore, it can be considered that the current color shift solution cannot improve the color shift phenomenon well because it will affect the panel transmittance.

### SUMMARY

The present disclosure provides a driving method and a driving device of display panel, and a display apparatus, as well as a storage medium based on data-based integrated drive circuit, which aims to effectively improve the color shift phenomenon without affecting the transmittance of the panel.

In order to achieve the above object, the present application provides a driving method of a display panel, the display panel includes a display array including pixel units arranged in an array; The driving method of the display panel comprises the following steps:

acquiring a first preset scanning driving signal and a second preset scanning driving signal, wherein a conduction duration of the first preset scanning driving signal is smaller than the conduction duration of the second preset scanning driving signal; and

taking a time duration of scanning two adjacent rows of pixel unit as a driving period, in a current driving period, driving odd column pixel units in a first row of pixel units with the first preset scanning driving signal, driving even column pixel units in the first row of pixel units with the second preset scanning driving signal, driving odd column pixel units in a second row of pixel units with the second preset scanning driving signal, driving even column pixel units in the second row of pixel units with the first preset scanning driving signal.

In addition, in order to achieve the above object, the application also provides a driving device of a display panel, the display panel comprises a display array, and the display array comprises pixel units arranged in an array; the driving device of the display panel includes:

an acquiring module, being configured to acquire a first preset scanning driving signal and a second preset scanning driving signal, wherein a conduction duration of the first preset scanning driving signal is smaller than the conduction duration of the second preset scanning driving signal; and

a driving module, being configured to take a time duration of scanning two adjacent rows of pixel unit as a driving period, in a current driving period, drive odd column pixel units in a first row of pixel units with the first preset scanning driving signal, drive even column pixel units in the first row of pixel units with the second preset scanning driving signal, drive odd column pixel units in a second row of pixel units with the second preset scanning driving signal, and drive even column pixel units in the second row of pixel units with the first preset scanning driving signal.

In addition, in order to achieve the above object, the present application also proposes a display apparatus including the driving device of display panel.

In addition, in order to achieve the above objects, the present application also proposes a storage medium, computer readable instructions are stored on the storage medium, and when the computer readable instructions are executed by a processor, the following steps are implemented:

acquiring a first preset scanning driving signal and a second preset scanning driving signal, wherein a conduction duration of the first preset scanning driving signal is smaller than the conduction duration of the second preset scanning driving signal; and

taking a time duration of scanning two adjacent rows of pixel unit as a driving period, in a current driving period, driving odd column pixel units in a first row of pixel units with the first preset scanning driving signal, driving even column pixel units in the first row of pixel units with the second preset scanning driving signal, driving odd column pixel units in a second row of pixel units with the second preset scanning driving signal, driving even column pixel units in the second row of pixel units with the first preset scanning driving signal.

According to the present disclosure, pixel units in a same row are driven in a way of inserting two scanning driving signals, and the conduction time of the first scanning signal in the scanning driving signal is set to be smaller than the conduction time of the second scanning signal, so that the charging times of the pixel units corresponding to the driving of the two scanning driving signals are different, the charging capacity of adjacent pixel units in the same row is different, the driving mode of inserting high-voltage pixel units and low-voltage pixel units in the same row is realized, and the purpose of reducing color shift is achieved.

### BRIEF DESCRIPTION OF THE ACCOMPANYING DRAWINGS

FIG. 1a is a relationship graph between the color shift curve and the ideal curve before improving;

FIG. 1b is a relationship graph between the color shift curve and the ideal curve after improving;

FIG. 2 is a schematic structural diagram of a display apparatus of a hardware operating environment of the embodiments in accordance with this disclosure;

FIG. 3a is a schematic structural diagram of an exemplary display array;

FIG. 3b is a driving timing diagram of an exemplary display array;

FIG. 4a is a schematic structural diagram of the display array of an embodiment in accordance with this disclosure;

FIG. 4b is a driving timing diagram of the display array of an embodiment in accordance with this disclosure;

FIG. 5 is a flowchart of the first embodiment of the driving method of display panel in accordance with this disclosure;

FIG. 6 is a waveform diagram of another embodiment of the display array in accordance with this disclosure;

FIG. 7 is a structural diagram of one embodiment of the driving device of display panel in accordance with this disclosure;

FIG. 8 is a structural diagram of another embodiment of the driving device of the display panel in accordance with this disclosure.

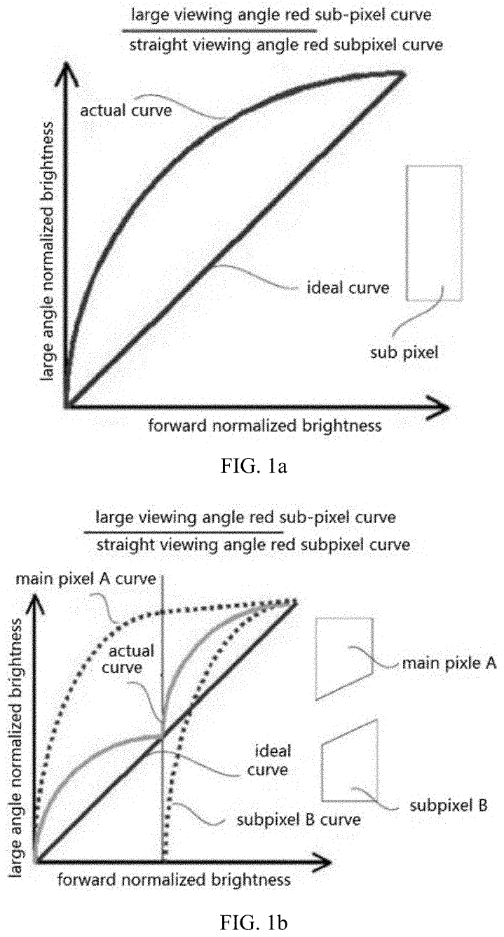

Various implementations, functional features, and advantages of this disclosure will now be described in further detail in connection with some illustrative embodiments and the accompanying drawings.

### DETAILED DESCRIPTION OF ILLUSTRATIVE EMBODIMENTS

It is understood that the specific embodiments described herein are merely illustrative of the disclosure and are not intended to limit the disclosure.

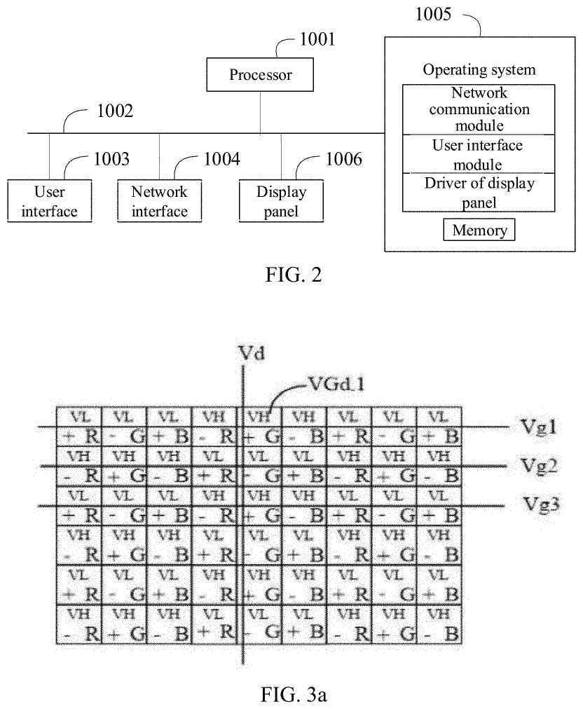

Referring to FIG. 2, FIG. 2 is a schematic structural diagram of a display panel of a hardware operating environment according to an embodiment of the present application.

As shown in FIG. 2, the display panel may include a processor 1001, such as a CPU, a communication bus 1002, a user interface 1003, a network interface 1004, and a memory 1005. The communication bus 1002 is used to implement connection and communication between these components. The user interface 1003 may include a display, an input unit such as a keyboard, and the user interface 1003 may optionally include a standard wired interface and a wireless interface. The network interface 1004 may optionally include a standard wired interface, a wireless interface (such as a Wi-Fi interface). The memory 1005 may be a high-speed RAM memory or a non-volatile memory, such as a magnetic disk memory. The memory 1005 may alternatively be a storage device independent of the aforementioned processor 1001, and the display panel 1006 may be a liquid crystal display panel or other display panels capable of performing the same or similar functions.

It will be understood by those skilled in the art that the display panel structure shown in FIG. 2 does not constitute a definition of the display panel and may include more or fewer components than shown, or some components may be combined, or different part arrangements may be used.

As shown in FIG. 2, the memory 1005 as a storage medium may include an operating system, a network communication module, a user interface module, and a driver of display panel.

In the display panel shown in FIG. 2, the network interface 1004 is mainly used to connect the network and communicate data with the internet. The user interface 1003 is mainly used to connect the user terminal and communicate data with the terminal. The processor 1001 and the memory 1005 in the display panel of the present application may be provided in a data driving integrated circuit that calls the driving sequence of the display panel stored in the memory 1005 through the processor 1001 and performs the operation of the driving method of the display panel.

Based on the above hardware structure, an embodiment of the driving method for the display panel of the present application is proposed.

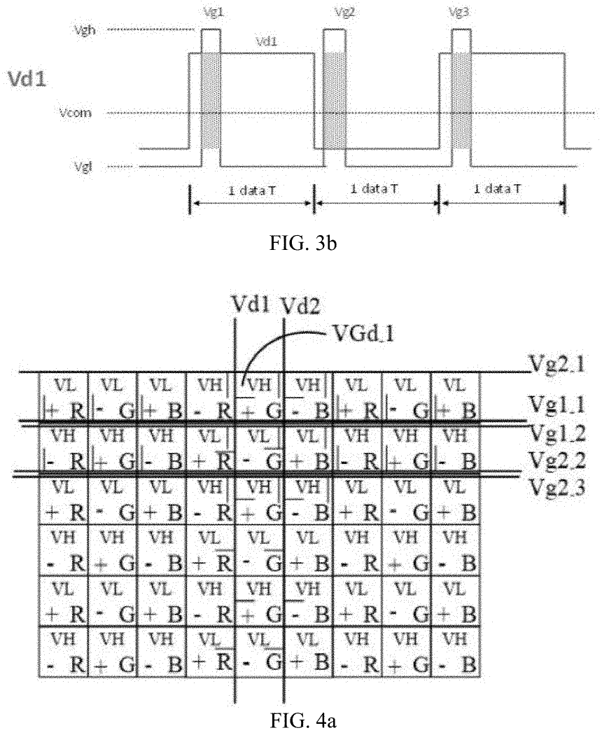

Referring to FIG. 3a, which is a schematic structural diagram of an exemplary display array, the original liquid crystal display panel designs scanning driving signals to pass through the same row of sub-pixels, and each row of scanning driving signals is as shown in the schematic driving timing diagram of the display array illustrated in FIG. 3b, wherein Vg1, Vg2, Vg3, etc. indicate that the driving voltages of each row of scanning driving signals are the same, and the corresponding relative timing and overlapping time of scanning driving signals with respect to the timing of data driving signals are the same, so each sub-pixel has the same charging capability. In order to solve the problem of color shift, high voltage sub-pixels and low voltage sub-pixels should be used in driving to achieve the effect of color shift improvement. therefore, the data driving voltage Vd should be sequentially driven according to the high and low voltages required by each sub-pixel, such as the high voltage sub-pixel driving voltage VGd_1 on FIG. 3a, the next adjacent low voltage sub-pixel VGd_2, and the same row of sub-pixels are sequentially driven by high voltage and low voltage sub-pixel signals, except for the difference in driving signals. If the driving polarities of the two adjacent sub-pixels are different, with the increase of panel resolution, the number of sub-pixels in the same row will increase the driving frequency and increase the load of the integrated circuit (IC), increasing the power consumption of the driving IC and the risk of the temperature rise of the driving IC.

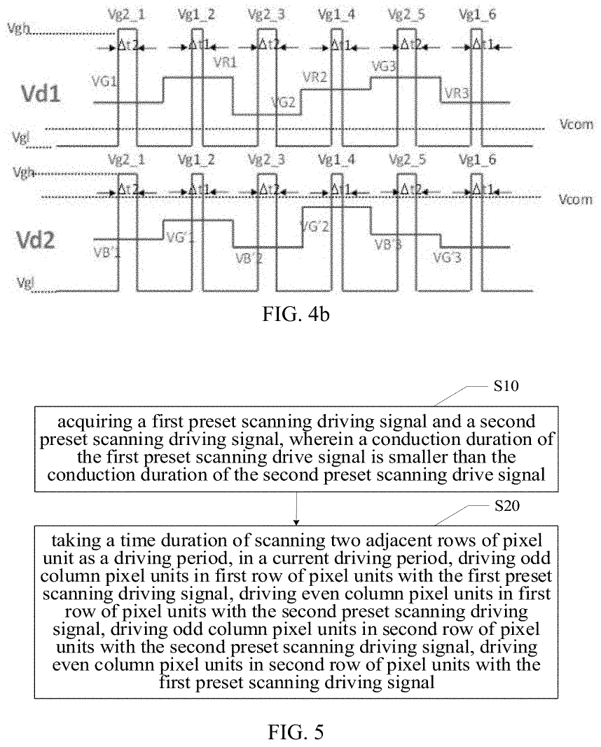

Referring to FIG. 4a, which is a schematic structural diagram of an embodiment of a display array, FIG. 4b is a schematic driving timing diagram corresponding to the display array of this embodiment. The display panel of the display array may be a liquid crystal display panel or other display panels capable of realizing the same or similar functions. This embodiment is not limited to this. In this embodiment, a liquid crystal display panel is taken as an example to illustrate, the display panel includes a display array including pixel cells arranged in an array. The pixel unit comprises a first pixel unit and a second pixel unit, the first pixel unit and the second pixel unit are alternately arranged in a first direction and a second direction, the pixel unit comprises a first sub-pixel, a second sub-pixel and a third sub-pixel, and the first sub-pixel, the second sub-pixel and the third sub-pixel respectively correspond to a red sub-pixel (R), a green sub-pixel (G) and a blue sub-pixel (B), wherein the first direction is a row direction and the second direction is a column direction.

Referring to FIG. 5, FIG. 5 is a flowchart of the first embodiment of the driving method of the display panel of the present disclosure.

In the first embodiment, the driving method of the display panel includes the following steps:

Step S10, acquiring a first preset scanning driving signal and a second preset scanning driving signal, wherein a conduction duration of the first preset scanning driving signal is smaller than the conduction duration of the second preset scanning driving signal.

It should be noted that, as shown in FIG. 4a, the first preset scan driving signal is Vg1, the second preset scan driving signal is Vg2, the first preset time is the on time Δt1 for the sub-pixel connected to the first preset scan driving signal, and the second preset time is the one time Δt2 for the sub-pixel connected to the second preset scan driving signal, wherein Δt1<Δt2, so that the charging capacity of the two adjacent sub-pixels in the same column is different, and the charging capacity of the sub-pixels connected with Vg2 is larger than that of the sub-pixels connected with Vg1, thereby causing the two adjacent subpixels in the same column to be alternately arranged by high voltage and low voltage.

Step S20, taking a time duration of scanning two adjacent rows of pixel unit as a driving period, in a current driving period, driving odd column pixel units in first row of pixel units with the first preset scanning driving signal, driving even column pixel units in first row of pixel units with the second preset scanning driving signal, driving odd column pixel units in second row of pixel units with the second preset scanning driving signal, driving even column pixel units in second row of pixel units with the first preset scanning driving signal.

In this embodiment, red (R), green (G) and blue (B) subpixels are taken as one pixel unit, and more subpixels such as white (W) may also be included. This embodiment is not limited to this. In order to realize that each pixel unit adopts a high-low voltage interleaved driving arrangement, the sub-pixels in each row of pixel units adopt two scanning driving lines and driving signals, the odd and even rows of pixel units in the same row of pixel units adopt different scanning driving lines, and the sub-pixels in each row of pixel units simultaneously turn on two scanning driving signals while driving the same row of pixel units. In addition, the driving circuit design of crossing between left and right adjacent sub-pixels is matched with the data driving signal, and the same data driving circuit is driven for the same polarity to reduce the frequent driving of polarity, thereby reducing the operation of the driving IC, reducing the power consumption of the driving IC and the risk of temperature rise of the driving IC, and achieving the driving mode of crossing arrangement of high-voltage pixel units and low-voltage pixel units, thus solving the problem of viewing angle color deviation, realizing high-voltage and low-voltage sub-pixels with different time sequences when scanning driving signals are switched, and avoiding resolution degradation because the difference between the high-voltage sub-pixels and the low-pixels will not be clearly perceived by the naked eye.

It can be understood that, as shown in the timing diagrams of FIGS. 4a and 4b, in order to realize that R, and B subpixels are used as pixel units, the pixel units adopt a high-low voltage interleaved driving arrangement, and two scanning driving circuits are designed for the same row of sub-pixels, one scanning driving signal is Vg2, the other scanning driving signal is Vg1, and the other scanning driving signal is Vg2, as shown in the even row of pixel units of the first row of sub-pixels in FIG. 4a. For odd-numbered column pixel units of the first row of subpixels, scanning drive lines and driving signals are co-scanned, as shown in the timing chart of FIG. 4b, the switching timing of the scanning driving signal controlling Vg1 is smaller for the data driving signal than for the Vg2 scanning driving signal, so that the subpixel charging capability corresponding to the Vg1 scanning drive line can be deteriorated, and the subpixel charging capability corresponding to the Vg2 scanning drive line can be improved, thereby achieving the purpose of normal charging of high voltage subpixels and secondary charging of low-voltage subpixels, and further achieving the effect of color deviation improvement. In addition, the driving circuit design with adjacent left and right sub-pixels interspersed with data driving signals enables the same polarity to drive the same data driving circuit, reduces the frequent driving of polarity, reduces the operation of the driving IC, reduces the power consumption of the driving IC and the temperature rise risk of the driving IC, and achieves the purpose of driving the high voltage pixel units and the low voltage pixel units interspersed with each other to solve the problem of viewing angle color shift.

In this embodiment, the pixel units in the same row are driven in a way of inserting two scanning driving signals, and the conduction time of the first scanning signal in the scanning driving signal is set to be less than the conduction time of the second scanning signal, so that the charging time of the pixel units corresponding to the driving of the two scanning driving signals is different, causing the charging capacity of adjacent pixel units in the same row to be different, realizing the driving mode of inserting and arranging high-voltage pixel units and low-voltage pixel units in the same row, thereby achieving the purpose of reducing color shift.

Further, the pixel unit includes first pixel units and second pixel units alternately arranged in the row direction and the column direction, respectively. Before step S10, the method further includes:

setting the polarities of adjacent subpixels of the first pixel unit and the second pixel unit to opposite polarities, and before the step S20, the method further includes:

driving each column of subpixels in the same column of the pixel units with a preset number of data driving signals.

It should be noted that in this embodiment, since the data driving signals are arranged in such a way that the left and right adjacent sub-pixels are alternately driven, the same polarity drives the same data driving signal without designing corresponding driving signals to drive according to the difference of driving signals of each sub-pixel, the driving frequency of the IC is less and the purpose of frequency reduction is achieved.

The data driving signal includes a first preset data driving signal and a second preset data driving signal; the method for driving each column of sub-pixels in the same column of pixel units by using a preset number of data driving signals comprises the following steps:

driving a first polarity subpixel in odd rows of subpixels in the same column of pixel units with a first preset data driving signal, and driving a second polarity subpixel in even rows of subpixels in the same column of pixel units with a second preset data driving signal.

Further, after the step S20, the method further includes:

driving two adjacent subpixels in a same column of pixel units with a third preset data driving signal, and the third preset data driving signal is an average value of historical driving signals of the two adjacent subpixels.

It should be noted that the historical driving signals of the adjacent two sub-pixels are the driving signals of the adjacent two sub-pixels in the same column before improvement, and the equivalent voltages of the equivalent driving voltages VGd_1 and VGd_2 of the adjacent two sub-pixels in the same column are driven by the positive driving voltage Vgd=VG1 and the negative driving voltage Vgd=VG1′, respectively. The positive drive voltage vg1 and the negative drive voltage vg1′ may preferably be the average signals of the original pixel signals Gd1 and Gd2, and 0 to 255 signals in terms of 8-bit driving signals, i.e., the positive drive voltage VG1 and the negative drive voltage VG1′ corresponding to G1=(Gd1+Gd2)/2, G1 signals. The equivalent voltages of VGd_3 and VGd_4 are driven by the positive drive voltage Vgd=VG2 and the negative drive voltage Vgd=VG2′, respectively, and may preferably be the average signals of the pixel signals gd3 and gd4 of the original frame and 0 to 255 signals in terms of the 8-bit driving signal, i.e., G2=(Gd3+Gd4)/2, G2 signals corresponding to the positive drive voltage vg2 and the negative drive voltage VG2′.

Further, the same row of sub-pixels are conducted with different preset time durations, where the preset time is alternately set for the second preset time and the first preset time.

As shown in the timing chart of FIG. 4b, the G positive sub-pixels VGd_1, VGd_3 and VGd_5 in the vd1 data driving signal correspond to the scan drive voltage Vg2 and the scan drive voltages corresponding to the r positive sub-pixels VRd_2, VRd_4 and VRd_6 are vg1, while the g negative sub-pixels VGd_2, VGd_4, VGd_6 in the Vd2 data driving signal correspond to Vg1. And the scan driving voltages corresponding to the b negative sub-pixels VBd_1, VBd_3, VBd_5 are Vg2, wherein the switching timing Δt1 of the scan driving signal of Vg1 is smaller than the switching timing Δt2 of the Vg 2 scan driving signal with respect to the data driving signal, that is Δt1<Δt2.

As shown in FIG. 4b, the vd1 driving signals are g positive driving and r positive driving in sequence, vd1=vg1, vr1, vg2, vr2, vg3, vr3 . . . , respectively, in conjunction with the scanning driving signals vg2_1, vg1_2, vg2_3, vg1_4, vg2_5, vg1_6, and the switching timings of the scanning driving signals are ΔT2, Δt1, A T2, Δt1, ΔT2, Δt1, respectively. VD2 driving signals at the same time are B negative polarity driving and G negative polarity driving in sequence, VD2=VB1′, VG1′, VB2′, VG2′, VB3′, VG3′ . . . , and are matched with scanning driving signals VG2_1, VG1_2, VG2_3, VG1_4, VG2_5, VG1_6, respectively. Switching timing of scanning driving signals is ΔT2, ΔT1, ΔT2, ΔT1, ΔT2, ΔT1, respectively. The switching timing Δt1<ΔT2 of the scanning driving signal can realize the interpenetrating arrangement of high-voltage pixel units and low-voltage pixel units with RGB subpixels as pixel units.

Further, an inversion signal is acquired, and the conduction duration of the first scan driving signal and the second scan driving signal is switched according to the inversion signal.

With the inversion of adjacent data driving signals, the switching timing of scan driving signals is also switched with respect to data driving signals ΔT1 and ΔT2, i.e. the switching timing of scan driving signals of VG1 is ΔT2 with respect to data driving signals, and the switching timing of scan driving signals of VG2 is ΔT1 with respect to data driving signals, so that sub-pixels with different timing and different high and low voltage signals can be realized, and since the difference between high voltage sub-pixels and low voltage sub-pixels cannot be seen clearly by naked eyes, resolution degradation is avoided.

Further, after the step S10, the method further includes:

the high-voltage driving signal in the first preset scanning driving signal and the high-voltage driving signal in the second preset scanning driving signal are driven with different driving voltages, and the low-voltage driving signal in the first preset scanning driving signal and the low-voltage driving signal in the second preset scanning driving signal are driven with different driving voltages.

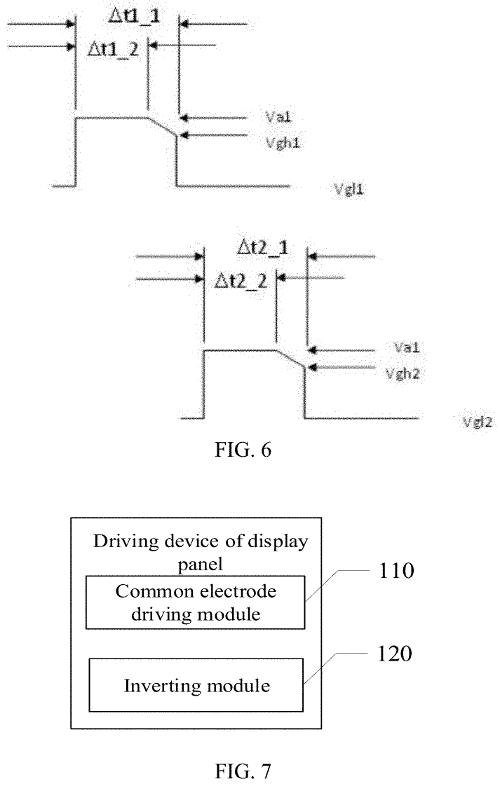

As shown in FIG. 6, a schematic diagram of the scan driving signal of another embodiment of the display array is provided. Besides adjusting the on-time of the scan signal, the scan driving signal can also be adjusted to achieve different charging effects. As shown in FIG. 6, the high voltage vgh1 of the first scan driving signal is different from the high voltage vgh2 of the second scan driving signal, the low voltage vgl1 of the first scan driving signal is different from the high voltage v gl2 of the second scan driving signal. So as to form the chamfered pair voltages va1 and va2. Due to the parasitic capacitance of the real panel causing the distortion of the scanning driving signal, the corresponding chamfered electrical design is required to achieve the improvement of in-plane uniformity. Due to the difference between va1 and va2, i.e., Δt1_1/Δt1_2 and ΔT2_1/ΔT2_2, the charging capacity of adjacent pixel cells in the same row is different, and the driving mode of alternating arrangement of high-voltage pixel cells and low-voltage pixel cells in the same row is realized so as to reduce color shift.

In addition, the embodiment of the application also provides a driving device for the display panel. As shown in FIG. 7, the display panel includes a display array including pixel units arranged in an array; the driving device of the display panel comprises:

an acquiring module 110 configured to acquire a first preset scanning driving signal and a second preset scanning driving signal, where a conduction duration of the first preset scanning driving signal is smaller than the conduction duration of the second preset scanning driving signal.

a driving module 120 configured to take a time duration of scanning two adjacent rows of pixel unit as a driving period, in a current driving period, drive odd column pixel units in first row of pixel units with the first preset scanning driving signal, drive even column pixel units in first row of pixel units with the second preset scanning driving signal, drive odd column pixel units in second row of pixel units with the second preset scanning driving signal, drive even column pixel units in second row of pixel units with the first preset scanning driving signal.

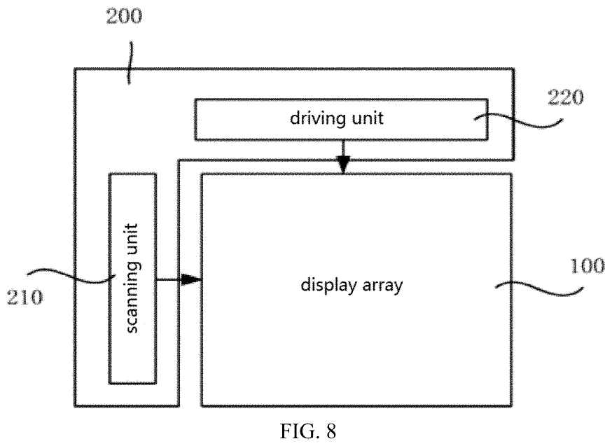

As shown in FIG. 8, the driving device of the display panel also includes a display array 100 and a driving module 200. The driving module 200 may include a scanning unit 210 and a driving unit 220. The scanning unit 210 is used to output scanning driving signals, typically scanning pixel units line by line, and the driving unit 220 outputs data driving signals so that the pixel units receive driving data for display when being scanned.

The driving module 200 can refer to the above embodiment. After this process, the pixel units in the same row are driven in a way that two scanning driving signals are inserted into each other, and the conduction time of the first scanning signal in the scanning driving signal is set to be less than the conduction time of the second scanning signal, so that the charging time of the pixel units corresponding to the driving of the two scanning driving signals is different, resulting in different charging capacities of adjacent pixel units in the same row, thus realizing the driving of adjacent pixel units in the same row in a driving way that high-voltage pixel units and low-voltage pixel units are inserted into each other, thereby achieving the purpose of reducing color shift.

In addition, the embodiment of the application also provides a storage medium on which computer-readable instructions are stored, wherein the computer-readable instructions when executed by the processor implement the driving method of the display panel.

The above is only the preferred embodiment of the present application and is not therefore limiting the scope of the patent of the present application. The equivalent structure or equivalent process changes made in the application specification and drawings, or directly or indirectly applied in other related technical fields, are similarly included in the patent protection scope of this application.

What is claimed is:

1. A driving method of a display panel, wherein the display panel comprises a display array, the display array comprises pixel units arranged in an array; the driving method comprises:
acquiring a first preset scanning driving signal and a second preset scanning driving signal, wherein a conduction duration of the first preset scanning driving signal is smaller than a conduction duration of the second preset scanning driving signal; and
taking a time duration of scanning two adjacent rows of pixel units as a driving period, in a current driving period, driving odd column pixel units in a first row of pixel units with the first preset scanning driving signal, driving even column pixel units in the first row of pixel units with the second preset scanning driving signal, driving odd column pixel units in a second row of pixel units with the second preset scanning driving signal, driving even column pixel units in the second row of pixel units with the first preset scanning driving signal.

2. The driving method of claim 1, wherein the pixel units comprise first pixel units and second pixel units alternately arranged in a row direction and a column direction respectively;
prior to the operation of acquiring a first preset scanning driving signal and a second preset scanning driving signal, wherein a conduction duration of the first preset scanning driving signal is smaller than a conduction duration of the second preset scanning driving signal, the driving method further comprises:
setting polarities of adjacent subpixels of the first pixel units and the second pixel units to opposite polarities.

3. The driving method of claim 2, wherein subsequent to the operation of taking a time duration of scanning two adjacent rows of pixel unit as a driving period, in a current driving period, driving odd column pixel units in a first row of pixel units with the first preset scanning driving signal, driving even column pixel units in the first row of pixel units with the second preset scanning driving signal, driving odd column pixel units in a second row of pixel units with the second preset scanning driving signal, driving even column pixel units in the second row of pixel units with the first preset scanning driving signal, the driving method further comprises:
driving each column of subpixels in a same column of the pixel units with a preset number of data driving signals.

4. The driving method of claim 3, wherein the data driving signals comprises a first preset data driving signal and a second preset data driving signal;
wherein the operation of driving each column of subpixels in a same column of the pixel units with a preset number of data driving signals comprises:
driving a first polarity subpixel in odd rows of subpixels in the same column of pixel units with the first preset data driving signal, and driving a second polarity subpixel in even rows of subpixels in the same column of pixel units with the second preset data driving signal.

5. The driving method of claim 3, subsequent to the operation of driving each column of subpixels in a same column of the pixel units with a preset number of data driving signals, the driving method further comprising:
driving two adjacent subpixels in the same column of pixel units with a third preset data driving signal, and the third preset data driving signal is an average value of historical driving signals of the two adjacent subpixels.

6. The driving method of claim 1, wherein subsequent to the operation of acquiring a first preset scanning driving signal and a second preset scanning driving signal, the driving method further comprises:
driving a high voltage driving signal in the first preset scanning driving signal and a high voltage driving signal in the second preset scanning driving signal with different driving voltages, and driving a low voltage driving signal in the first preset scanning driving signal and a low voltage driving signal in the second preset scanning driving signal with different driving voltages.

7. The driving method of claim 1, wherein subsequent to the operation of acquiring a first preset scanning driving signal and a second preset scanning driving signal, the driving method further comprises:
conducting subpixels in a same row with different preset conduction durations, wherein the conduction duration of the first preset scanning driving signal and the conduction duration of the second preset scanning driving signal are alternately set.

8. The driving method of claim 1, wherein subsequent to the operation of acquiring a first preset scanning driving signal and a second preset scanning driving signal, the driving method further comprises:
switching the conduction durations of the first scanning driving signal and the second scanning driving signal according to an inversion signal when the inversion signal is acquired.

9. The driving method of claim 1, wherein the driving method further comprises:
the pixel units comprises first pixel units and second pixel units, the first pixel units and the second pixel units are alternately arranged in a first direction and a second direction, wherein the first direction is a row direction and the second direction is a column direction.

10. The driving method of claim 1, wherein the pixel units comprises a first subpixel, a second subpixel, and a third subpixel;
prior to the operation of acquiring a first preset scanning driving signal and a second preset scanning driving signal, the driving method further comprises:
the first subpixel, the second subpixel and the third subpixel are respectively and correspondingly set as a red subpixel, a green subpixel and a blue subpixel.

11. A driving device of a display panel, wherein the display panel comprises a display array, the display array comprises pixel units arranged in an array; the driving device of display panel comprises a processor and a nonvolatile memory, the nonvolatile memory stores executable instructions executable by the processor, the executable instructions comprise:
an acquiring module, being configured to acquire a first preset scanning driving signal and a second preset scanning driving signal, wherein a conduction duration of the first preset scanning driving signal is smaller than the conduction duration of the second preset scanning driving signal; and
a driving module, being configured to take a time duration of scanning two adjacent rows of pixel unit as a driving period, in a current driving period, drive odd column pixel units in a first row of pixel units with the first preset scanning driving signal, drive even column pixel units in the first row of pixel units with the second preset scanning driving signal, drive odd column pixel units in a second row of pixel units with the second preset scanning driving signal, and drive even column pixel units in the second row of pixel units with the first preset scanning driving signal.

12. The driving device of claim 11, wherein the pixel units comprise first pixel units and second pixel units alternately arranged in a row direction and a column direction respectively;
prior to the operation of acquiring a first preset scanning driving signal and a second preset scanning driving signal, wherein a conduction duration of the first preset scanning driving signal is smaller than a conduction duration of the second preset scanning driving signal, the acquiring module is further configured to:
set polarities of adjacent subpixels of the first pixel units and the second pixel units to opposite polarities.

13. The driving device of claim 12, wherein subsequent to the operation of taking a time duration of scanning two adjacent rows of pixel unit as a driving period, in a current driving period, driving odd column pixel units in a first row of pixel units with the first preset scanning driving signal, driving even column pixel units in the first row of pixel units with the second preset scanning driving signal, driving odd column pixel units in a second row of pixel units with the second preset scanning driving signal, driving even column pixel units in the second row of pixel units with the first preset scanning driving signal, the driving module is further configured to:
drive each column of subpixels in a same column of the pixel units with a preset number of data driving signals.

14. The driving device of claim 13, wherein the data driving signal comprises a first preset data driving signal and a second preset data driving signal;
wherein the operation of driving each column of subpixels in a same column of the pixel units with a preset number of data driving signals comprises:
driving a first polarity subpixel in odd rows of subpixels in the same column of pixel units with the first preset data driving signal, and driving a second polarity subpixel in even rows of subpixels in the same column of pixel units with the second preset data driving signal.

15. The driving device of claim 13, subsequent to the operation of driving each column of subpixels in a same column of the pixel units with a preset number of data driving signals, the driving module is further configured to:
drive two adjacent subpixels in the same column of pixel units with a third preset data driving signal, wherein the third preset data driving signal is an average value of historical driving signals of the two adjacent subpixels.

16. The driving device of claim 11, wherein subsequent to the operation of acquiring a first preset scanning driving signal and a second preset scanning driving signal, the driving module is further configured to:
drive a high voltage driving signal in the first preset scanning driving signal and a high voltage driving signal in the second preset scanning driving signal with different driving voltages, and drive a low voltage driving signal in the first preset scanning driving signal and a low voltage driving signal in the second preset scanning driving signal with different driving voltages.

17. The driving device of claim 11, wherein subsequent to the operation of acquiring a first preset scanning driving signal and a second preset scanning driving signal, the driving module is further configured to:
conduct subpixels in a same row with different preset conduction durations, wherein the conduction duration of the first preset scanning driving signal and the conduction duration of the second preset scanning driving signal are alternately set.

18. The driving device of claim 11, wherein subsequent to the operation of acquiring a first preset scanning driving signal and a second preset scanning driving signal, the driving module is further configured to:
switch the conduction durations of the first scanning driving signal and the second scanning driving signal according to an inversion signal when the inversion signal is acquired.

19. The driving device of claim 11, wherein the pixel units comprises first pixel units and second pixel units, the first pixel unit and the second pixel unit are alternately arranged in a first direction and a second direction, wherein the first direction is a row direction and the second direction is a column direction.

20. A display apparatus, wherein the display apparatus comprises a driving device of a display panel, the driving device comprises a processor and a nonvolatile memory storing computer readable instructions, when the computer readable instructions are executed by the processor, the following operations are implemented:
acquiring a first preset scanning driving signal and a second preset scanning driving signal, wherein a conduction duration of the first preset scanning driving signal is smaller than the conduction duration of the second preset scanning driving signal; and
taking a time duration of scanning two adjacent rows of pixel unit as a driving period, in a current driving period, driving odd column pixel units in a first row of pixel units with the first preset scanning driving signal, driving even column pixel units in the first row of pixel units with the second preset scanning driving signal, driving odd column pixel units in a second row of pixel units with the second preset scanning driving signal, driving even column pixel units in the second row of pixel units with the first preset scanning driving signal.
